(19) United States
(12) Patent Application Publication
(10) Pub. No.: US 2009/0045097 A1
(43) Pub. Date: Feb. 19, 2009

(54) Device and Method Using a Quilted Pouch for Packing and Shipping Flat Screens

(76) Inventors: Wayne Moss, Albuquerque, NM (US); Ken Pollock, Moriarity, NM (US)

Correspondence Address: YORGOS D. MARINAKIS, 1600 BLACKHAWK RIVER DR. NE, RIO RANCHO, NM, 87144-6416, US

(21) Appl. No.: 11/840,951

(22) Filed: Aug. 18, 2007

(51) Int. Cl. B65D 81/113; B65G 7/00

(52) U.S. Cl. 206/591; 414/426

(57) ABSTRACT

A non-form fitting fabric pouch for protecting flat screens from damage white moving or shipping. A method for protecting flat screens from damage white moving or shipping, comprising placing a pouch of fabric over a flat computer monitor, and alternatively additionally comprising placing the covered screens on the shelf of a cart.

### CROSS-REFERENCE TO RELATED APPLICATIONS

Not applicable.

### STATEMENTS REGARDING FEDERALLY SPONSORED RESEARCH AND DEVELOPMENT

Not applicable.

### BACKGROUND

The present invention satisfies the need of packing flat screens, such as flat computer monitors and flat screen televisions, for moving or shipping without damage to the screens.

Information relevant to attempts to address this problem can be found in U.S. Pat. Nos. 6,557,325; and 7,106,202; which are not admitted to be prior art with respect to the present invention by its mention in this Background Section. However, it is desirable to have better apparatuses and/or methods than what is disclosed in each of the identified references.

The pertinent fields of the art follow:
International Classification: B65D-81/02 (IPC) and B65D-85/40 (IPC).
U.S. Classification: 206/591.

### SUMMARY

Because consumers of all types seldom save the boxes in which flat screens such as computer monitors are bought, these monitors require substantial repacking before they can be moved or shipped without damage to the screens. If bubble wrap and tape are used to pack the screens, it is seldom reusable, thus resulting in increased cost and waste. If the screens are wrapped in moving quilts, the wrapped screens take up a disproportionate amount of space in the moving van or shipping container. The embodiments of the present invention address these problems by providing a reusable, space-saving pouch and method for packing flat screens, such as flat computer monitors and flat televisions screens, for moving and shipping without damage to the screens.

The use of form fitting fabric covers to protect electronic screens is currently known and practiced (i.e., the ProSeries Big Screen TV Cover). However, the used of a non-form fitting protective fabric cover is not known or practiced. Only one patent relates to the use of a cushion device, without a box, for the protection of computer monitors for moving and shipping: U.S. Pat. No. 6,557,325, which teaches wrapping computer components with a cushioned plastic pillow containing two layers of bubble wrap. Such bubble wrap will tend to last only a few uses. In addition, U.S. Pat. No. 7,106,202 discloses and claims a fabric pouch for shipping. However, the pouch additionally comprises a protective insert and a zippered mouth, and it is used in the manner of a mailer, not as a device cover. In summary, the references neither disclose nor claim a non-fitted fabric pouch for placing over a flat screen to protect it for moving and shipping. Further, the references neither disclose nor claim a fabric pouch having no protective insert and having no closed mouth.

The embodiments of the present invention comprise a non-form fitting fabric pouch made from fabric which is then placed over the flat screen. The pouch is made from a single, generally rectangular panel of fabric, which is an highly economical use of material, especially in comparison with the extra material that is needed to make a form-fitting cover. The single panel of fabric is folded back on itself and sewed at two sides, having one folded edge and leaving one side open as a mouth to receive the flat screen. In one embodiment, the two upper corners are folded inward towards the pouch interior prior to sewing the perimeter. The form-fitting cover in contrast requires an extra panel of fabric to account for the thickness of the screen.

In the best mode, the fabric from which the pouch is made is the same fabric as that of a moving blanket.

The method entails placing a non-form fitting fabric pouch over a flat screen prior to moving or shipping the flat screen. This method is both highly effective and easy to use.

In the best mode of the method, the method additionally entails the use of a cart with at least one shelf, where one or more flat screens are covered with the pouch or pouches and placed on the shelf standing upright on their bases.

The previously described embodiments of the invention have many advantages. The container is a pouch; it is not form fitting, so it can be simply and quickly constructed from a single panel of fabric. The pouch is reusable. The pouch and method are both highly effective at protecting screens, and are easy to use.

### DRAWINGS

These and other features, aspects and advantages of the embodiments of the apparatus and/or methods will become better understood with reference to the following description, appended claims and accompanying drawings where:

FIG. 1 shows an embodiment of the invention in its basic form;

FIG. 2 shows a pouch which is placed over a flat screen;

FIG. 3 shows an embodiment of the invention in which the two upper corners of the panel were folded inward towards the pouch interior prior to sewing the perimeter;

FIG. 4 shows how a plurality of pouches can be used in conjunction with a cart having at least one shelf; and

FIG. 5 shows a flowchart of the method of using a pouch;

FIG. 6 shows a flowchart of the method of using the pouches in conjunction with a cart having at least one shelf.

### REFERENCE NUMERALS FOR DRAWINGS

100 a non-form fitting fabric pouch;
110 a perimeter;
111 upper corner;
115 flexible body panel;
116 sealed edge;
117 folded edge;
120 a mouth;
125 pouch interior;
130 a flat screen;
140 a flat screen base;
150 a cart; and
160 a shelf.

### DESCRIPTION

### Definitions

Moving blankets are also known as quilted moving blankets, moving quilts, (quilted) moving pads, and (quilted) furniture pads, and are typically made of polyester or cotton outer fabric and thick cotton inner fitting; they can be woven, non-woven, or a combination of the two.

Flat screens include flat computer monitors, flat television screens and flat electronic screens of all types.

### Description

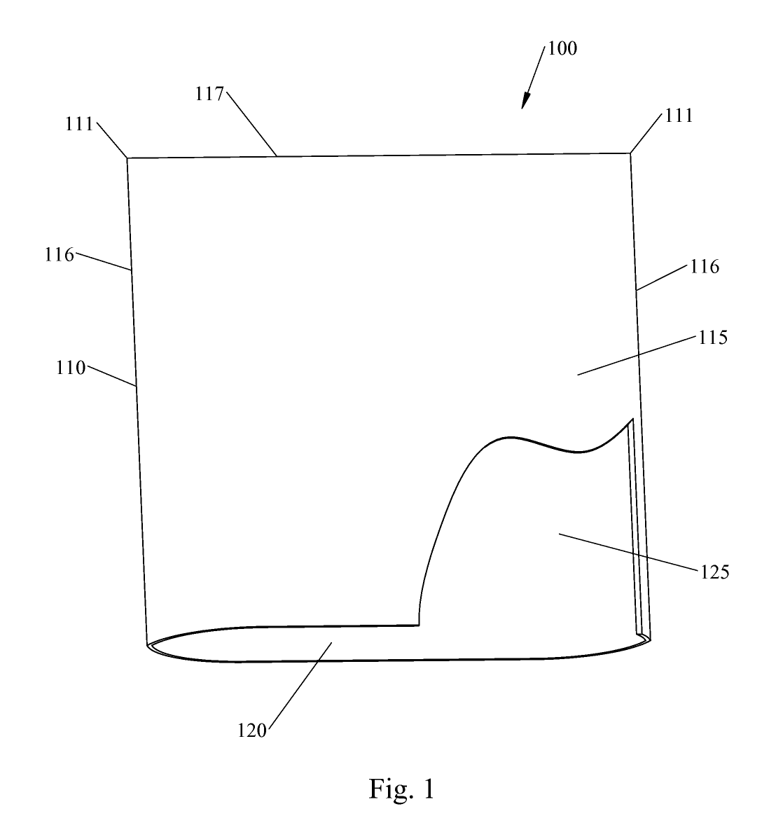

FIG. 1 shows a non-form fitting fabric pouch 100. The non-form fitting fabric pouch 100 is made from a single, generally rectangular flexible body panel 115 of fabric such as a moving blanket. The panel 115 is folded back on itself and sewn around the perimeter 110 at two sides to form two sealed edges 116 and one folded edge 117, leaving one side open as a mouth 120 to receive the flat screen 130 (not shown). The interior 125 of the resultant non-form fitting fabric pouch 100 is large enough to receive the flat screen 130 (not shown) such as a flat computer monitor, but not so large as to constitute wasted fabric. The container may alternately have a plastic sleeve sewn onto its exterior, for receiving moving or shipping identification labels.

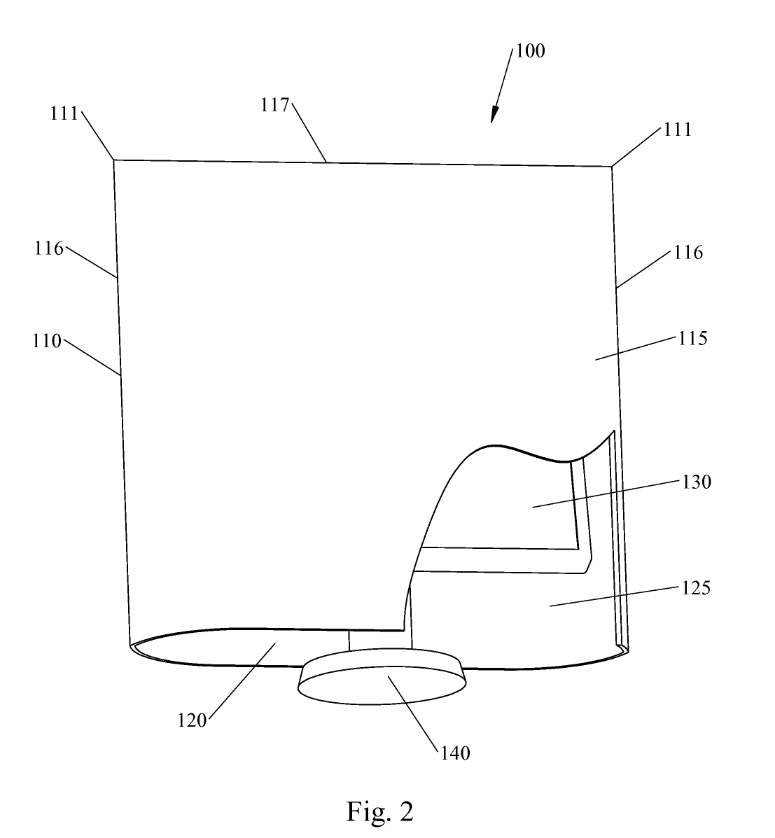

FIG. 2 shows a non-form fitting fabric pouch 100 which is placed over a flat screen 130. The flat screen 130 stands upright on its base 140.

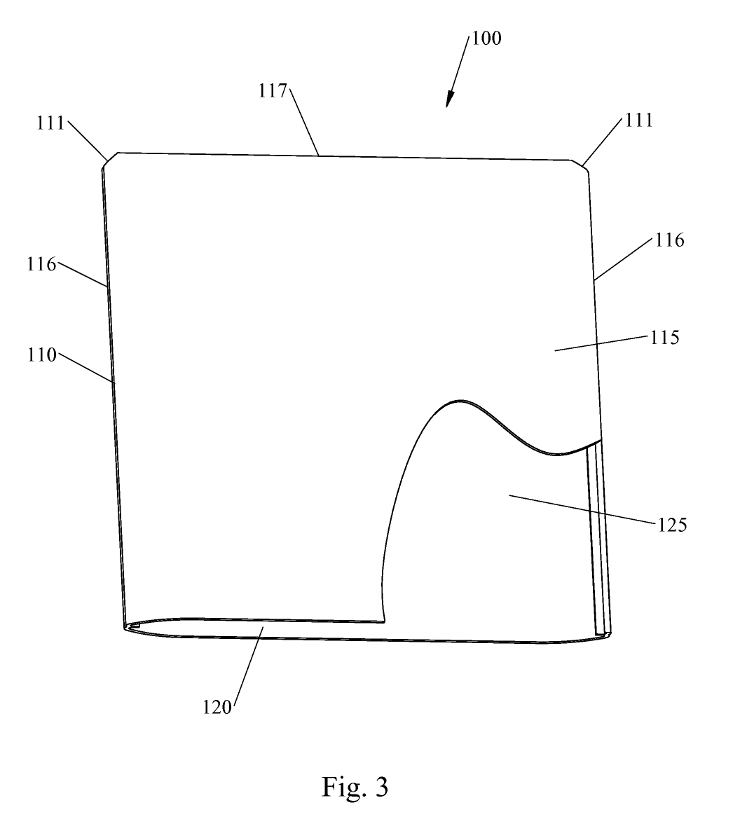

FIG. 3 shows an embodiment of the invention in which the two upper corners 111 of the non-form fitting fabric pouch 100 were folded inward towards the pouch interior 125 prior to sewing two sides of the perimeter 110.

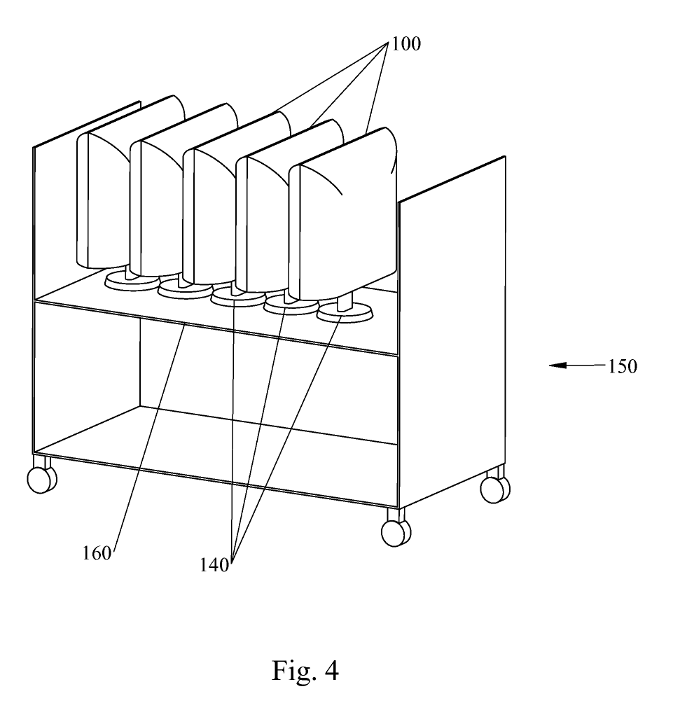

FIG. 4 shows a plurality of non-form fitting fabric pouches 100 used in conjunction with a cart 150. One or more flat screens 130 are covered with non-form fitting fabric pouches 100, such that the flat screen occupies the pouch interior 125. These pouch-covered flat screens 130 are then placed on a shelf 160 of the cart 150.

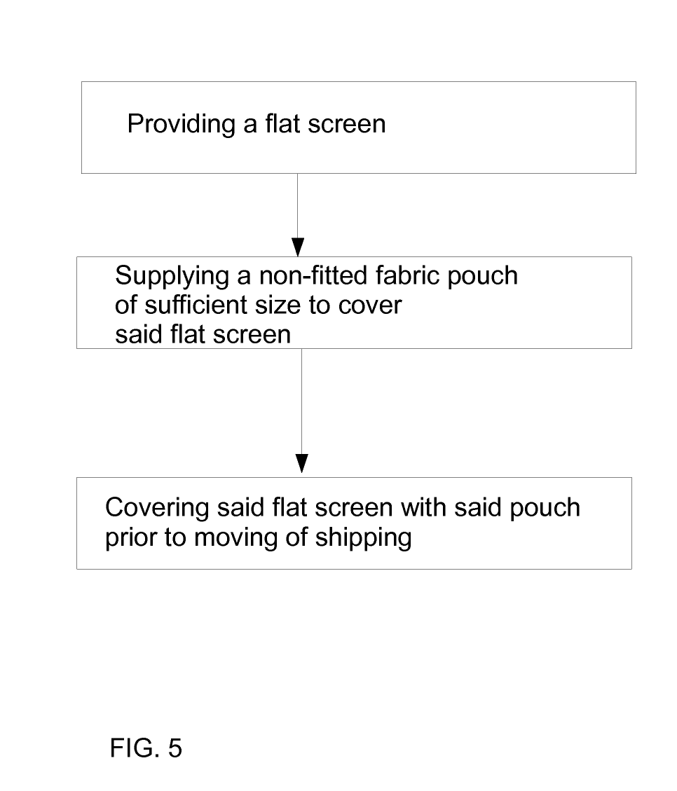

FIG. 5 shows a flowchart of the method, which entails placing a pouch 100 over a flat screen 130. The method comprises three steps: providing a flat screen 130; supplying a non-fitted fabric pouch 100 of sufficient size to cover the flat screen 130; and covering the flat screen 130 with the non-fitted fabric pouch 100 prior to moving or shipping the flat screen 130, such that the flat screen 130 occupies the pouch interior 125.

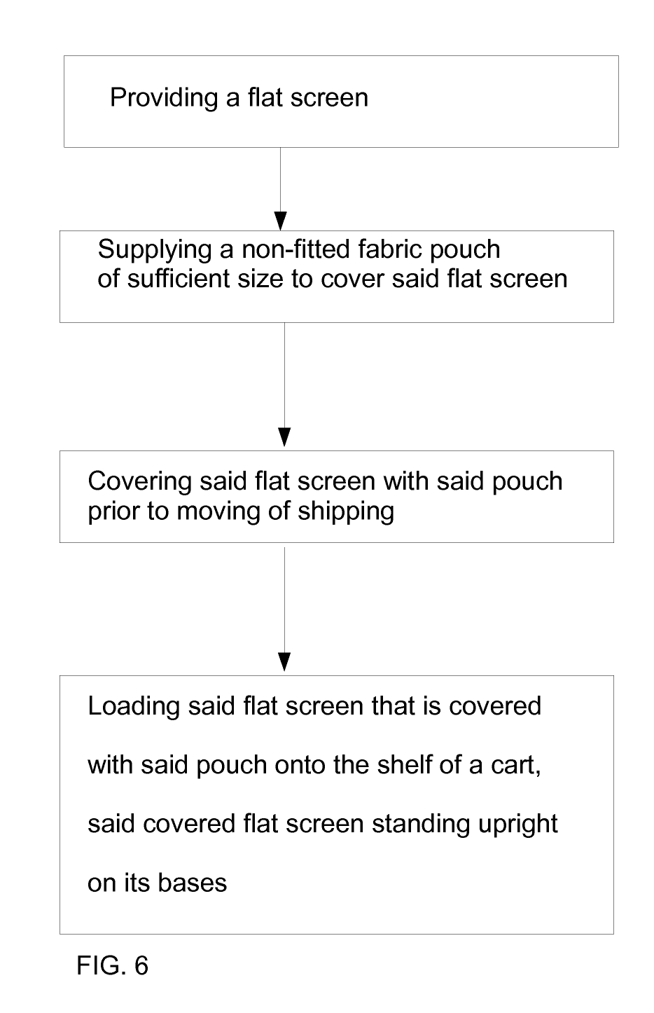

FIG. 6 shows a flowchart of an alternate embodiment of the method, which additionally entails the use of a cart 150 with at least one shelf 160, where the flat screens 130, covered with non-fitted fabric pouches 100, and placed on the shelf 160 standing upright on their bases 140. This method is both highly effective and easy to use. It comprises four steps: providing a flat screen 130; supplying a non-fitted fabric pouch 100 of sufficient size to cover the flat screen 130; covering the flat screen 130 with the non-fitted fabric pouch 100 prior to moving or shipping the flat screen 130; and loading one or a plurality of the flat screens 130 that are covered with the non-fitted fabric pouches 100 onto the shelf or shelves 160, the covered flat screens 130 standing side-by-side and upright on their bases 140.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, the fabric could be burlap, and the perimeter could be sealed by means other than sewing such as by clasps. Therefore, the spirit and scope of the appended claims should not be limited to the description of the versions contained therein.

What is claimed is:

1. A container adapted to receive a flat screen for moving or shipping comprising a non-form fitting fabric pouch having a pouch interior and a mouth communicating with said interior, said pouch having a perimeter and including a single flexible body panel that is folded over onto itself, said folded panel joined about a majority of the perimeter to define a sealed edge with an unjoined portion defining said mouth, said pouch of sufficient size to cover said flat screen.

2. The container according to claim 1, wherein said pouch is made from a moving blanket.

3. A method for protecting a flat screen for moving or shipping, comprising the steps of:
A. providing a flat screen;
B. supplying a non-fitted fabric pouch of sufficient size to cover said flat screen;
C. covering said flat screen with said pouch prior to moving or shipping.

4. The method of claim 3 in which a plurality of flat screens are loaded onto a cart with at least one shelf, additionally comprising loading said flat screens that are covered with said pouches onto said shelf, said covered flat screens standing side-by-side and upright on their bases.
